(19) United States
(12) Patent Application Publication
(10) Pub. No.: US 2022/0369809 A1
(43) Pub. Date: Nov. 24, 2022

(54) Microwave Oven Lift Kit

(71) Applicant: Catina Oliver-Spivey, Owings, MD (US)

(72) Inventor: Catina Oliver-Spivey, Owings, MD (US)

(21) Appl. No.: 17/746,395

(22) Filed: May 17, 2022

Related U.S. Application Data
(60) Provisional application No. 63/189,820, filed on May 18, 2021.

(51) Int. Cl. A47B 77/10; H05B 6/64; F24C 15/30; A47B 77/08; G10L 15/22

(52) U.S. Cl. CPC A47B 77/10; H05B 6/6426; F24C 15/30; A47B 77/08; G10L 15/22; G10L 2015/223

(57) ABSTRACT

The Hideaway is the only product of its kind that has the capability of freeing up countertops by raising or lowering a microwave effortlessly, within minutes into a kitchen island. Hideaway is uniquely designed with a seamless countertop piece that is attached to the microwave top to ensure discretion and a seamless display while the microwave is stored within the island.

### BACKGROUND

Kitchen countertops are a necessity in all homes as they are used either for cooking, placing large kitchen appliances atop for storage, such as: toasters, microwaves, etc. and other purposes. Considering countertops are utilized heavily on an inconvenient and frustrating situation for individuals attempting to manage and/or make the most of such limited space. There have been no products available as original equipment or as an aftermarket to address this problem.

An apparatus to simplify the process of using the microwave without continuously occupying necessary counter space. There have been no products available as original equipment or as an aftermarket to address this problem.

There exists a need for a device and a system to be able to bring the microwave out to use and then put away, that is not being met by any known or disclosed device or system of present.

### SUMMARY OF THE INVENTION

The main purpose of the microwave lift kit is to provide users with a hydraulic lift platform for microwaves that lifts the microwave when needed at countertop height and automatically lowers it back into a kitchen island for recessed use for handicapped users and for freeing up countertop space, after use. The present invention overcomes the above referred to difficulties in a convenient, simple and efficient manner.

A microwave oven kit comprising a countertop having a thickness and a top surface comprising a cutout having the same thickness and a top surface and a bottom surface attached to a top of the microwave oven. The disclosure also includes a lift mechanism configured to lift and to recess the microwave oven based respectively on a clearance of the countertop top surface and the cutout top surface and on a flush alignment thereof. The disclosure yet includes a lift mechanism control configured to set the clearance of the countertop top surface to the cutout top surface to a height of the microwave oven plus the thickness of the countertop cutout.

### BRIEF DESCRIPTION OF THE DRAWINGS

FIG. 1 is a perspective view of a countertop lifted microwave oven in accordance with an embodiment of the present disclosure.

FIG. 2 is a perspective view of a countertop recessed microwave oven in accordance with an embodiment of the present disclosure.

Throughout the description, similar reference numbers may be used to identify similar elements depicted in multiple embodiments. Although specific embodiments of the invention have been described and illustrated, the invention is not to be limited to the specific forms or arrangements of parts so described and illustrated. The scope of the invention is to be defined by the claims appended hereto and their equivalents.

### DETAILED DESCRIPTION

Reference will now be made to exemplary embodiments illustrated in the drawings and specific language will be used herein to describe the same. It will nevertheless be understood that no limitation of the scope of the disclosure is thereby intended. Alterations and further modifications of the inventive features illustrated herein and additional applications of the principles of the inventions as illustrated herein, which would occur to one skilled in the relevant art and having possession of this disclosure, are to be considered within the scope of the invention.

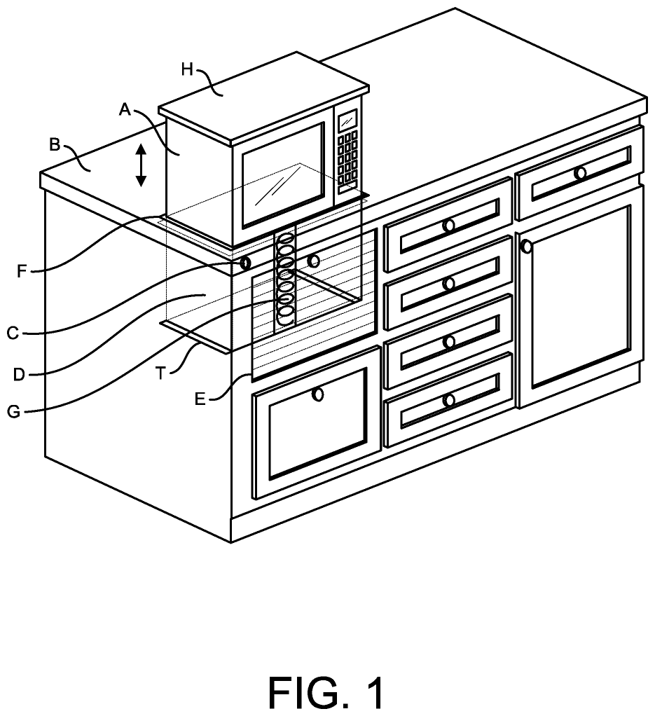

FIG. 1 is a perspective view of the countertop lifted microwave showing the external view of the following: Microwave on a lift which is implemented as a spring in some embodiments and as a hydraulic lilt in other embodiments and goes up when in use A. Also shown are the Kitchen island B. Control button to raise microwave up or push down/in with voice control and remote control capability C. When the Microwave is recessed inside the countertop island it is still accessible from a a corner of the kitchen island at a lower height for wheelchair users and users of reduced height and storage when not in use D. A Sliding door enables access to the microwave when inside E. Under-mount channels around microwave F give structural support and attachment between the microwave and the lift kit. A Hydraulic lift to raise and lower microwave G, a Seamless countertop piece is attached to microwave top H, in accordance with an embodiment of the present disclosure. Also depicted are drawer slides T which enable the microwave oven to slide out from underneath the countertop for access to wheelchair, handicapped and shorter users.

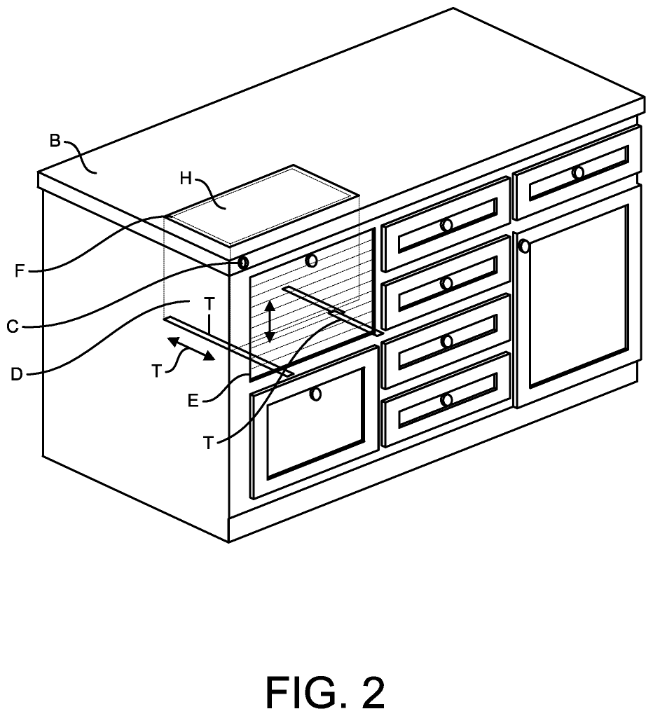

FIG. 2 is a perspective view of the countertop recessed microwave oven showing the external view of the following: Kitchen island B, Control. button to raise microwave up or push down/in with voice control and remote control capability C. Microwave inside island for reduced height use and even storage from the countertop. Sliding door to access microwave when inside E. Under-mount channels around microwave F. Seamless countertop piece attached to microwave top H, in accordance with an embodiment of the present disclosure. Also depicted are drawer slides T which enable the microwave oven to slide out from underneath the countertop for access to wheelchair, handicapped and shorter users.

The present disclosed Microwave Lift, also known as “Hideaway” allows individuals to use a common household appliance, a microwave oven also known as a ‘microwave,’ within the island to improve countertop use and free up space on the countertop and enable disabled wheelchair users a reduced height use option. Expanding on the initial design of a standard kitchen island, Hideaway introduces a novel lift kit sectioned within the design that is fully controlled via a remote control whereas the control button enables the user to choose the desired microwave placement. Under-mount channels surround the perimeter of the microwave as it sits securely on top of the electro-mechancially controlled lift and remote functions feature a cutting edge motion, proximity and voice control technology that enables the user to vocally command the setting of the microwave or by the wave of their hand.

In addition, the piece possesses a strategically placed sliding door which also guarantees individuals are capable of accessing the microwave when placed in the recessed mode. Ultimately, Hideaway enhances functionality of modern countertops and allows users to create space for other objects thereby redefining how the area can be used to promote a smoother operation in the kitchen, by limiting the interference of large appliances.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

What is claimed is:

1. A microwave oven kit comprising:
a countertop having a thickness and a top surface comprising a cutout having the same thickness and a top surface and a bottom surface attached to a top of the microwave oven;
a lift mechanism configured to lift and to recess the microwave oven based respectively on a clearance of the countertop top surface and the cutout top surface and on a flush alignment thereof;
a lift mechanism control configured to set the clearance of the countertop top surface to the cutout top surface to a height of the microwave oven plus the thickness of the countertop cutout.

2. The microwave oven kit of claim 1, wherein the lift mechanism control further comprises a voice activation circuit configured to trigger the lift mechanism by a voice command.

3. The microwave oven kit of claim 1, wherein the lift mechanism control further comprises a proximity activation circuit configured to trigger the lift mechanism by a proximal hand wave.

4. The microwave oven kit of claim 1, wherein the lift mechanism control further comprises a mechanical button switch configured to trigger the lift mechanism by a depression and release thereof.

5. The microwave oven kit of claim 1, further comprising a button switch configured to trigger the lift mechanism by a depression thereof and stop the lift by a release thereof

6. The microwave oven kit of claim 1, wherein the lift mechanism is a hydraulic lift attached to a bottom of the microwave oven.

7. The microwave oven kit of claim 1, wherein the lift mechanism is a spring attached to a bottom of the microwave oven and coiled based on the flush alignment and at rest based on the clearance thereof.

8. The microwave oven kit of claim 1, further comprising a drawer slide attached to a bottom of the microwave oven and configured to slide the oven forward from under the countertop.

9. The microwave oven kit of claim 1, wherein the clearance is equal to a height of a door of the microwave oven plus the thickness of the cutout.

10. The microwave oven kit of claim 1, further comprising a height of a bottom of the microwave oven accessible to a wheelchair user based on a cabinet base for the countertop.

11. The microwave oven kit of claim 1, further comprising a sliding door for access to the microwave oven and sliding within a cabinet base for the countertop.

12. The microwave oven kit of claim 1, further comprising mounting channels between the lift mechanism and a bottom of the microwave oven.

13. The microwave oven kit of claim 1, wherein the cutout is positioned proximal a corner of the countertop.

14. The microwave oven kit of claim 1, wherein the cutout is positioned proximal an edge of the countertop.

15. The microwave oven kit of claim 1, wherein the microwave oven is recessed a depth of a height of the microwave oven plus the thickness of the cutout and countertop.
